(19) United States
(12) Patent Application Publication
(10) Pub. No.: US 2021/0054591 A1
(43) Pub. Date: Feb. 25, 2021

(54) FRONT-END LOADER HAVING A DOUBLE BOOM WITH A DOGLEG BEND OF 105 TO 135 DEGREES INCLUDING AN EXTENSION POWERED BY HYDRAULIC CYLINDERS

(71) Applicant: Larry Irby Williams, Beckville, TX (US)

(72) Inventor: Larry Irby Williams, Beckville, TX (US)

(21) Appl. No.: 16/546,117

(22) Filed: Aug. 20, 2019

(51) Int. Cl. E02F 3/34; E02F 3/42; E02F 9/18; A01D 87/12; E02F 3/38; E02F 9/22; B66F 9/22

(52) U.S. Cl. CPC E02F 3/3417; E02F 3/422; E02F 9/18; B66F 9/22; E02F 3/38; E02F 9/2271; A01D 87/127

(57) ABSTRACT

A front-end loader for attachment to a tractor. The front-end loader includes a support structure configured to be attached to the tractor, and two extendable booms, each boom including a proximal leg and a distal leg, the distal leg configured to be attached to an accessory, such as a bucket. The extendable booms each have a boom extension hydraulic cylinder for extending the boom by up to 2 to 4 feet, in addition to a lift hydraulic cylinder to lift each boom, and a tilt hydraulic cylinder to tilt the accessory. The extendable booms greatly enhance the capability of the front-end loader to position its payload higher and farther than a standard front end loader, while preserving the stability and lifting capacity of the front-end loader. The booms have a traditional “dogleg” bend of 105 to 135 degrees that provides the two booms with a wide range of motion.

### FIELD OF THE INVENTION

This invention relates generally to powered loaders, and more particularly to tractor front-end loaders that include booms that are shaped in an obtuse dogleg bend, or an equivalent curved bend.

### BACKGROUND OF THE INVENTION

Front-end loaders are popular additions to compact utility tractors and larger farm tractors. Compact utility tractors (CUT) are small tractors typically having 18 to 50 horsepower, and are often used to perform grounds maintenance, landscaping, and farming tasks. Most commonly these tractors are 2-wheel drive, although some CUTs are 4-wheel drive. Typically, front-end loaders include two booms, each boom being either a traditional “dogleg” style, or a curved arm style.

Front-end loaders on compact utility tractors are capable of many tasks and can include many optional accessories. For example, bucket accessories are commonly used to move dirt, sand, and gravel from one area to another, and a toothbar accessory can be added to the front edge of the bucket to aid with digging. Some front-end loaders are equipped with a quick coupler, otherwise known as a quick attach system. The quick attach system allows accessories, such as the bucket, to be removed easily and then allows another accessory to be quickly attached. Other common accessories include pallet forks for lifting pallets of goods, or bale spears for lifting bales of hay or other soft materials.

In the agricultural industry, as well as in the construction industry, the majority of front-end loaders that are attached to a compact utility tractor or a farm tractor are of the same structure. Typically, the front-end loader includes two booms, each boom being an obtuse angled “dogleg” boom that has a fixed, hinged point of attachment that serves as a load bearing base. The two booms are usually made of tubular boxed steel, and included is a “cross piece” toward the front of the assembly that holds the two booms together at a fixed distance with respect to each other.

Working on materials located at the ground level immediately in front of the tractor is a very common work application for front-end loaders. An example of this application would be using a front-end loader bucket accessory to scoop up gravel from a pile of gravel located immediately in front of the tractor. To manipulate materials at ground level immediately in front of the tractor, the booms must be lowered to a position where the front ends of the booms are near, or are at, the ground level.

To accomplish lowering the accessory to ground level, traditionally each boom has a “dogleg” obtuse angular bend of 105 to 135 degrees. This “dogleg” bend prevents the booms, when in the lowered position, from striking against the front wheels of the tractor, or from striking against other parts of the tractor, such as the front fenders. The “dogleg” bend allows the booms to arch over the tractor wheel areas and to extend down to the ground area in front of the tractor, allowing an accessory, such as a bucket, to work at the ground level immediately in front of the tractor.

In addition, the “dogleg” bend in each boom allows the accessory, such as the bucket or the bale spears, to place the payload onto the truck or the wagon without the underside of the booms striking against the side of the truck or against parts of the wagon.

The “dogleg” bend in each boom is located midway between the hinged point of attachment of the boom to the tractor at the load bearing base, and the traveling end of the boom where the bucket (or other accessory) is mounted to the boom.

In recent years, to add a “stylish” or “streamlined” look to their products, some loader manufacturers have replaced the obtuse dogleg angle in the midsection of the boom with a gentle continuous arc bend that runs from one end of the boom to the other end. Nevertheless, this continuous arc bend accomplishes the same objectives as an obtuse 105 degree to 135 degree dogleg bend—namely, to arch over the front wheel areas of the tractor, while still having the front ends of the booms extend to reach the ground level immediately in front of the tractor.

Front-end loaders mounted on compact utility tractors are traditionally used to load material on a truck such as a dump truck, and lift bales of hay or other materials onto a flatbed truck or a hay wagon. Unfortunately, the terrain of the construction/work site and/or the height of the truck may prevent the front-end loader from effectively reaching the height of the truck so that the material can be placed on the truck (or wagon). In addition, if the front-end loader attempts to lift and place a bale on top of other bales that have already been placed on the truck, the front-end loader booms may not have adequate reach to lift and place the bale at such a high position.

In an effort to address this issue of inadequate boom length, a commercially available telescopic front-end loader is sold by Kishan Equipment of Rajkot, India (www.kishanloader.com) for use in the cotton industry. This front-end loader has a double boom configuration, with each boom being extendable by hydraulic power to increase the boom length, and therefore extend the reach of the loader. However, the two booms are of a straight design, and therefore do not have the 105 to 135 degree angle that is typical of a common front end loader. Because the booms are straight and have no bend, this design cannot be used to manipulate materials immediately in front of the tractor, since when lowered, the straight booms would not be able to reach ground level without striking the front wheels of the tractor. The wheels therefore prevent the straight booms from reaching the ground level immediately in front of the tractor.

Also, this front-end loader of Kishan Equipment of India has booms that extend outward approximately from 7 to 17 feet in front of the tractor. Extending the booms to such a great length reduces the stability and lifting capacity of the entire machine. In addition, the substantial weight of the booms, combined with the large forward boom extension length, add a large tilting force to the tractor. To compensate for the large tilting force of the long booms, the tractor must include a large compensating rear counterweight that is mounted on the back of the tractor. However, the mounting of the large rear counterweight on the tractor eliminates the availability of the tractor's rear draw bar and rear power lift, and the rear placement of the large weight makes the mounting of any rear accessories impossible. This greatly reduces application of this machine to handling only lightweight materials, and prevents the tractor from having any rear accessory tools.

### SUMMARY OF THE INVENTION

The front-end loader of the invention includes a boom extension that extends the lift height and reach of the front end loader by 2 to 4 feet, greatly enhancing the capability of the front-end loader to position its payload higher and farther than a standard front end loader. The 2 to 4 feet boom extension does not significantly reduce the stability and lifting capacity of the front-end loader. This maximum extension length of 2 to 4 feet may require additional counterweights, but this can be entirely accomplished by using rear wheel weights that are a standard option on most tractor models. Requiring only rear wheel weights allows the rear drawbar and the power lift of the tractor to be available for use while the front-end loader is in service, and rear accessories or tools, such as a back hoe, can be left in place attached to the rear of the tractor, saving the tractor operator time and effort.

The front-end loader of the invention includes booms having a traditional “dogleg” bend of 105 to 135 degrees that are found in most front-end loader booms. The dogleg booms allow the booms to arch over the tractor wheel areas and to extend down to the ground area in front of the tractor, enabling an accessory, such as a bucket, to work at the ground level, immediately in front of the tractor. In addition, the “dogleg” bend in each boom allows the accessory, such as the bucket or bale spears, to place the payload on a structure, such as a truck or a wagon, without the underside of the booms striking against the structure being loaded.

As an example, if the booms of the front-end loader are in an elevated position to lift a bale of hay onto a flatbed truck, but the lifted bale is not high enough to place on top of the other bales already on the truck, at this point in the lift cycle the boom extension can be actuated an additional 2 to 4 feet, and the forward extended reach can therefore place the bale at the desired height. In another example, if the booms of the front-end loader are in an elevated position to retrieve a bale of hay from the far side of a flatbed truck, but the bale spears cannot reach the far side of the bed of the truck, at this point in the lift cycle the boom extension can be actuated an additional 2 to 4 feet, and the forward extended reach can therefore reach the bales at the far side of the truck.

The front-end loader of the invention has extendable booms that can include linear bearings or wear pads to provide a long service life.

A general aspect of the invention is a front-end loader for attachment to a tractor or a rubber tired construction backhoe, the front-end loader including hydraulic cylinders, each hydraulic cylinder having a cylinder barrel, a piston rod, a proximal end, and a distal end. The front-end loader includes: a support structure configured to be attached to the tractor, the support structure having an upper attachment portion and a lower attachment portion; two booms, each boom including: a proximal leg having a pivot end and an extension end, the pivot end being pivotally attached to the upper attachment portion, and a boom extension hydraulic cylinder, having the proximal end attached to the proximal leg, and a distal leg having an extension end and an accessory support end, the extension end of the distal leg being attached to the distal end of the boom extension hydraulic cylinder; a lift hydraulic cylinder having the proximal end pivotally attached to the lower attachment portion of the support structure, and the distal end pivotally attached to the extension end of the proximal leg; and a tilt hydraulic cylinder having the proximal end being pivotally attached to the extension end of the distal leg, and the distal end of the tilt hydraulic cylinder configured to pivotally attach to an implement assembly that is configured to be pivotally attached to the accessory support end of the distal leg.

In some embodiments, the distal leg of each boom includes an extension shaft that is fixedly attached to the extension end of the distal leg, and the extension shaft is slidably supported by a receptacle included within the extension end of the proximal leg. In further embodiments, the receptacle within the extension end of the proximal leg includes wear pads to slidably support the extension shaft of the distal leg to provide a long service life.

In some embodiments, the two booms have a cross member attached to each boom of the two booms.

In some embodiments, each boom extension hydraulic cylinder extends each boom by 2 to 4 feet.

In some embodiments, the boom extension hydraulic cylinder is configured to extend and retract the two booms AFTER the lift hydraulic cylinder has raised the two booms to a raised position.

In some embodiments, the front-end loader further includes conventional wheel weights to provide additional counter weight for added stability.

In some embodiments, the distal leg extends from the proximal leg at a 105 to 135 degree boom legs angle.

In some embodiments, the distal end of each distal leg of the two booms is configured to attach to at least one of: a bucket, pallet forks, hay forks, bale spears.

### BRIEF DESCRIPTION OF THE FIGURES

Many additional features and advantages will become apparent to those skilled in the art upon reading the following description, when considered in conjunction with the accompanying drawings, wherein:

FIG. 1A is a side view of the front-end loader showing the accessory support end in a lowered position, the lift hydraulic cylinder in the retracted position, the boom extension hydraulic cylinder in the retracted position, and also having the extension shaft of the distal leg fully retracted into the receptacle of the proximal leg of the boom.

FIG. 1B is a perspective front and side view of the front-end loader of FIG. 1A mounted on the tractor and attached to a bucket accessory, showing the front-end loader and the bucket in a lowered position, having each lift hydraulic cylinder in the retracted position, each boom extension hydraulic cylinder in the retracted position, and also having the extension shaft of each distal leg fully retracted into the receptacle of the proximal leg of each boom.

FIG. 2A is a side view of the front-end loader showing the accessory support end in a lowered position, the lift hydraulic cylinder in the retracted position, the boom extension hydraulic cylinder in the partially extended position, and also having the extension shaft of the distal leg partially extended from the receptacle of the proximal leg of the boom, thereby extending the reach of each boom.

FIG. 2B is a perspective front and side view of the front-end loader of FIG. 2A mounted on the tractor and attached to a bucket accessory, showing the front-end loader and the bucket in a lowered position, having each lift hydraulic cylinder in the retracted position, each boom extension hydraulic cylinder in the extended position, and also having the extension shaft of each distal leg fully extended from the receptacle of the proximal leg of each boom, thereby extending the forward reach of each boom.

FIG. 3 is a perspective front and side view of the front-end loader mounted on the tractor and attached to the bucket accessory, showing the front-end loader and the bucket in a raised position, having each lift hydraulic cylinder in the extended position, each boom extension hydraulic cylinder in the retracted position, and showing the extension shaft of each distal leg fully retracted into the receptacle of the proximal leg of each boom.

FIG. 4 is a perspective front and side view of the front-end loader mounted on the tractor and attached to the bucket accessory, showing the front-end loader and the bucket in a raised position, having each lift hydraulic cylinder in the extended position, each boom extension hydraulic cylinder in the extended position, and showing the extension shaft of each distal leg fully extended from the receptacle of the proximal leg of each boom, thereby extending the height and reach of each boom and the bucket.

FIG. 5A is an isometric side view of the proximal leg, showing a proximal leg attachment hole configured to attach to the upper attachment portion of the support structure, a proximal leg attachment pin configured to attach to the proximal end of the boom extension hydraulic cylinder, two lift cylinder attachment holes configured to attach the proximal leg to the distal end of the lift hydraulic cylinder, and hidden lines showing the proximal leg receptacle configured to receive the extension shaft of the distal leg.

FIG. 5B is an isometric side view of the distal leg, showing the extension shaft, a distal leg attachment pin configured to attach to the distal end of the boom extension hydraulic cylinder, two tilt cylinder attachment holes configured to attach to the proximal end of the tilt hydraulic cylinder, and two accessory attachment holes configured to attach to an accessory, such as the bucket accessory.

FIG. 6 is an isometric side view of the proximal leg and the distal leg, the proximal leg receptacle receiving and supporting the extension shaft of the distal leg, the extension shaft partially extended from the proximal leg.

FIG. 7A is a cross sectional view of the proximal leg, showing four wear pads configured to slidably support the extension shaft of the distal leg.

FIG. 7B is an isometric view of the distal end of the proximal leg, also showing a hidden line view of a plurality of wear pads lining the proximal leg receptacle.

FIG. 8 is a perspective front and side view of the front-end loader mounted on the tractor and attached to a pallet forks accessory, showing the front-end loader and the pallet forks in a lowered position, having each lift hydraulic cylinder in the retracted position, each boom extension hydraulic cylinder in the retracted position, and the extension shaft of each distal leg fully retracted into the proximal leg receptacle of each boom.

FIG. 9A is a side view of a partially loaded truck and the front-end loader mounted on the tractor, showing the pallet forks accessory in a raised position, although not at an adequate height to place the pallet forks payload upon the truck, also showing the front-end loader having each lift hydraulic cylinder in the extended position, each boom extension hydraulic cylinder in the retracted position, and the extension shaft of each distal leg being fully retracted into the receptacle of the proximal leg of each boom.

FIG. 9B is a side view of the partially loaded truck and the front-end loader of FIG. 9A, having the pallet forks accessory in the raised position, and showing each boom extension hydraulic cylinder in the extended position, thereby bringing the pallet forks to a sufficient height and reach so as to place the pallet forks payload upon the truck, also showing the extension shaft of each distal leg being fully extended from the receptacle of the proximal leg of each boom.

FIG. 10A is a hydraulic circuit diagram of a hydraulic circuit including a hydraulic reservoir, a hydraulic pump, a hydraulic control valve, and a hydraulic cylinder, showing the hydraulic control valve in the neutral position, and the hydraulic cylinder piston rod in a static position.

FIG. 10B is a hydraulic circuit diagram of the hydraulic circuit of FIG. 10A, showing the hydraulic control valve in the open forward flow position, and the hydraulic cylinder piston rod extending.

FIG. 10C is a hydraulic circuit diagram of the hydraulic circuit of FIG. 10A, showing the hydraulic control valve in the open reverse flow position, and the hydraulic cylinder piston rod retracting.

FIG. 11A is a hydraulic circuit diagram of a hydraulic circuit configured to control two hydraulic cylinders, including a hydraulic reservoir, a hydraulic pump, two hydraulic control valves, and two hydraulic cylinders, showing the upper hydraulic control valve in the open forward flow position and the upper hydraulic cylinder piston rod extending, and also showing the lower hydraulic control valve in the neutral position and the lower hydraulic cylinder piston rod in a static position.

FIG. 11 B is a hydraulic circuit diagram of the hydraulic circuit of FIG. 11A, showing the upper hydraulic control valve in the neutral position and the upper hydraulic cylinder piston rod in a static position, and also showing the lower hydraulic control valve in the open forward flow position and the lower hydraulic cylinder piston rod extending.

### DETAILED DESCRIPTION

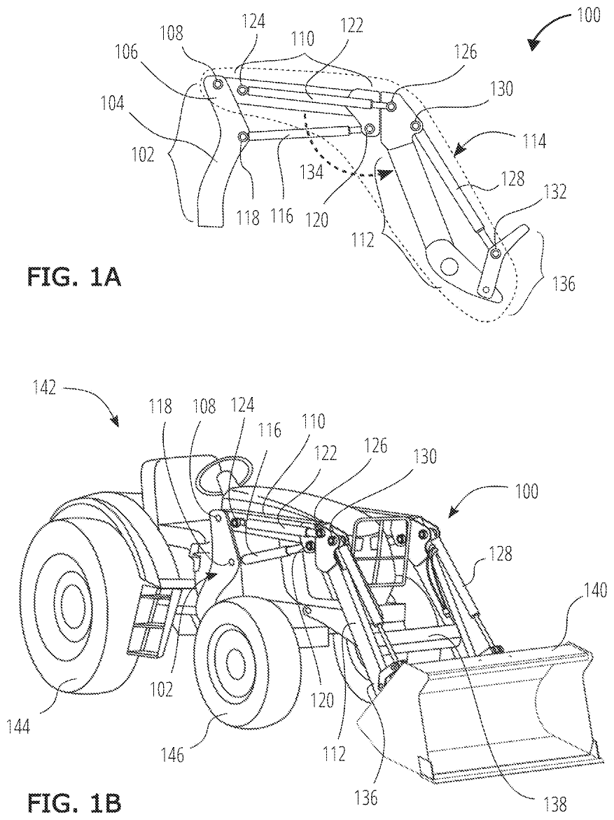

With reference to FIG. 1A, a side view of a front-end loader 100 is shown having an extendable boom 114, and including a proximal leg 110 and distal leg 112. The boom 114 is shown having a boom extension hydraulic cylinder 122 in a retracted position, and having a lift hydraulic cylinder 116 in a retracted position, corresponding to the distal leg 112 accessory support end 136 being in a lowered position.

The front-end loader 100 includes a support structure 102 configured to be mounted on a tractor 142 (shown in FIG. 1B). The support structure 102 includes a lower attachment portion 104 that pivotally supports the proximal end of the lift hydraulic cylinder 116 at the proximal lift attachment 118. The support structure 102 also includes an upper attachment portion 106 configured to pivotally support the proximal leg 110 of the boom 114 at the proximal leg pivot 108.

When the boom 114 is in the lowered position, the lift hydraulic cylinder 116 is in the retracted position. The distal end of the lift hydraulic cylinder 116 is pivotally attached to the distal end of the proximal leg 110 at the distal lift attachment 120. As the lift hydraulic cylinder 116 extends, the proximal leg 110 and the boom 114 are raised, and as the lift hydraulic cylinder 116 retracts, the proximal leg 110 and the boom 114 are lowered.

The distal leg 112 of the boom 114 is extendable from the proximal leg 110. In this view, the boom extension hydraulic cylinder 122 is shown in the retracted position, and therefore the distal leg 112 is in the retracted position with respect to the proximal leg 110. The proximal end of the boom extension hydraulic cylinder 122 is attached to the proximal end of the proximal leg 110 at a proximal extension attachment 124. The distal end of the boom extension hydraulic cylinder 122 is attached to the proximal end of the distal leg 112 at the distal extension attachment 126.

The distal leg 112 includes a tilt hydraulic cylinder 128 which controls the tilt angle of an accessory, such as a bucket 140 (shown in FIG. 1B), the accessory being attached to and supported by the accessory support end 136. The tilt hydraulic cylinder 128 is pivotally attached to the proximal end of the distal leg 112 by a proximal tilt attachment 130, and also is pivotally attached to the accessory support end 136 by a distal tilt attachment 132.

In this embodiment, the distal leg 112 extends from the proximal leg 110 at a boom legs angle 134 of 105 to 135 degrees.

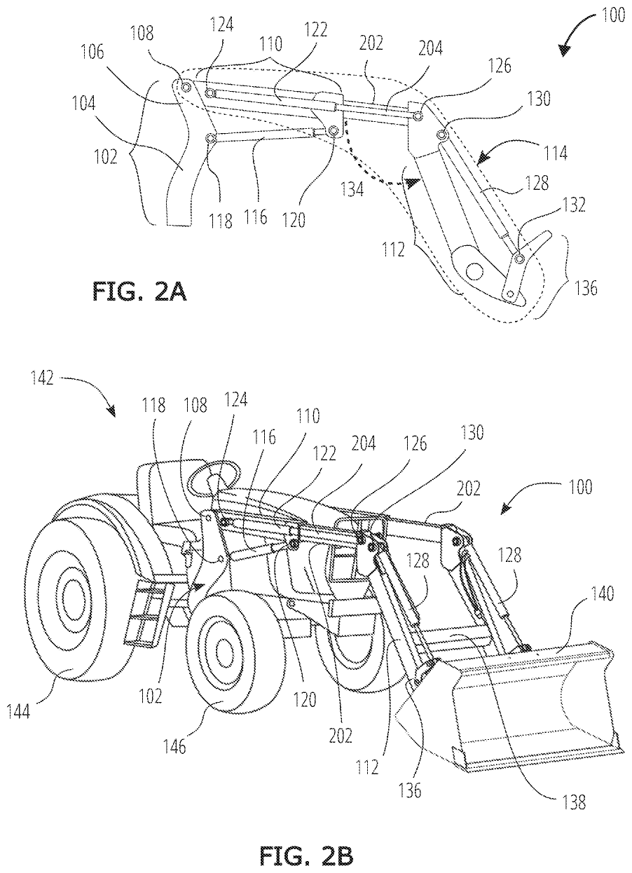

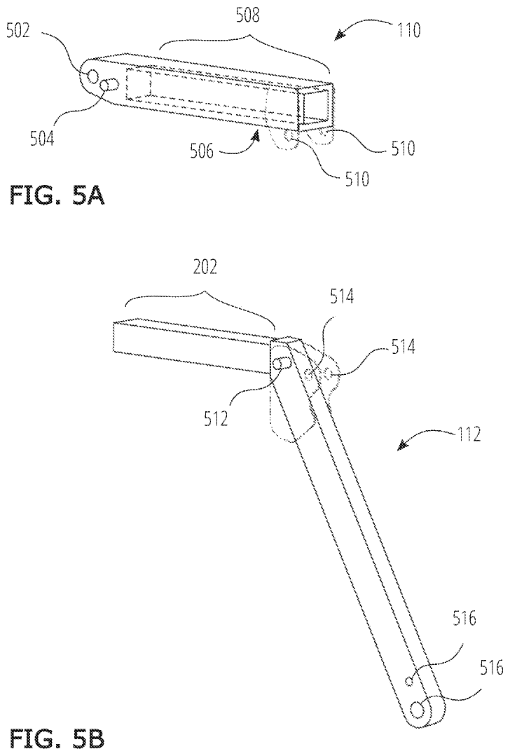

With reference to FIG. 1B, a perspective front and side view is shown of the front-end loader 100, having the support structure 102 mounted on the tractor 142. The front-end loader 100 includes, as an accessory, the bucket 140. The front-end loader 100 and the bucket 140 are shown in a lowered position, having each lift hydraulic cylinder 116 in the retracted position. Also, each boom 114 (shown in FIG. 1A) is in the retracted position, having each boom extension hydraulic cylinder 122 in the retracted position, and having each extension shaft 202 (shown in FIG. 2A) of the distal leg 112 fully retracted into the proximal leg receptacle 508 (shown in FIG. 5A) of the proximal leg 110 of each boom 114. Each boom 114 of the two booms is attached to a cross member 138 configured to hold the two booms at a fixed distance apart and to provide structural support for the front-end loader 100.

The tractor 142 includes two rear wheels 144 and two front wheels 146. In this embodiment, the distal leg 112 extends from the proximal leg 110 at a boom legs angle 134 of 105 to 135 degrees to prevent each distal leg 112 from striking against each of the front wheels 146 when the two booms are in the lowered position.

In some embodiments, the two rear wheels 144 can include conventional wheel weights (not shown) attached to the rear wheels 144 to provide additional counter weight for added stability, and to counter-balance the weight of the front-end loader 100 and the weight of an accessory attached to the accessory support end 136.

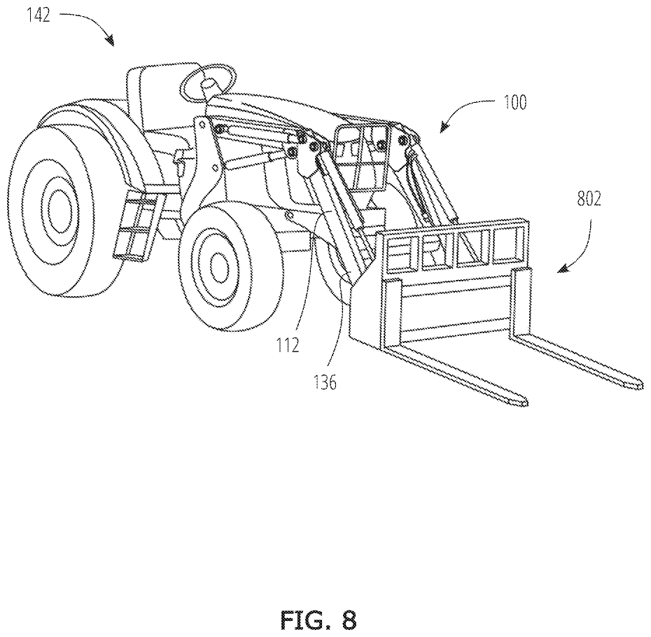

In some embodiments, the accessory support end 136 is configured to attach to one of: the bucket 140, pallet forks 802 (shown in FIG. 8), hay forks (not shown), and bale spears (not shown).

With reference to FIG. 2A, a side view of a front-end loader 100 is shown having an extendable boom 114, including a proximal leg 110 and distal leg 112. The boom 114 is shown in an extended position having both the extension shaft 202 and an extension cylinder piston rod 204 in extended positions. The lift hydraulic cylinder 116 is in the retracted position corresponding to the distal leg 112 of the boom 114 being in a lowered position. The front-end loader 100 includes the support structure 102 configured to be mounted on the tractor 142 (shown in FIG. 2B). The support structure 102 includes a lower attachment portion 104 that pivotally supports the proximal end of a lift hydraulic cylinder 116 at the proximal lift attachment 118. The support structure 102 also includes an upper attachment portion 106 configured to pivotally support the proximal leg 110 of the boom 114 at the proximal leg pivot 108.

The distal end of the lift hydraulic cylinder 116 is pivotally attached to the distal end of the proximal leg 110 at the distal lift attachment 120. As the lift hydraulic cylinder 116 extends, the proximal leg 110 and the boom 114 are raised, and as the lift hydraulic cylinder 116 retracts, the proximal leg 110 and the boom 114 are lowered.

The distal leg 112 of the boom 114 is extendable from the proximal leg 110. The distal leg 112 is shown in the extended position corresponding to the boom extension hydraulic cylinder 122 being in the extended position, and both the extension shaft 202 and an extension cylinder piston rod 204 in extended positions.

The proximal end of the boom extension hydraulic cylinder 122 is attached to the proximal end of the proximal leg 110 at a proximal extension attachment 124. The distal end of the boom extension hydraulic cylinder 122 is attached to the proximal end of the distal leg 112 at the distal extension attachment 126.

The distal leg 112 includes a tilt hydraulic cylinder 128 which controls the tilt angle of an accessory, such as the bucket 140 (shown in FIG. 2B), the accessory being attached to and supported by the accessory support end 136. The tilt hydraulic cylinder 128 is pivotally attached to the proximal end of the distal leg 112 by a proximal tilt attachment 130, and also is pivotally attached to the accessory support end 136 by a distal tilt attachment 132.

In this embodiment, the distal leg 112 extends from the proximal leg 110 at a boom legs angle 134 of 105 to 135 degrees.

With reference to FIG. 2B, a perspective front and side view is shown of the front-end loader 100, having the support structure 102 mounted on the tractor 142. The front-end loader 100 includes, as an accessory, the bucket 140. The front-end loader 100 and the bucket 140 are shown in a lowered position, having each lift hydraulic cylinder 116 in the retracted position. Also, each boom 114 (shown in FIG. 2A) is in the extended position, having each boom extension hydraulic cylinder 122 in the extended position, and having each extension shaft 202 of the distal leg 112 fully extended from the proximal leg receptacle 508 (shown in FIG. 5A) of the proximal leg 110 of each boom 114. Each boom 114 of the two booms is attached to a cross member 138 configured to hold the two booms at a fixed distance apart and to provide structural support for the front-end loader 100.

The tractor 142 includes two rear wheels 144 and two front wheels 146, and in this embodiment, the distal leg 112 extends from the proximal leg 110 at a boom legs angle 134 of 105 to 135 degrees to prevent each distal leg 112 from striking against the front wheels 146 when the two booms are in the lowered position.

In some embodiments, the two rear wheels 144 can include conventional wheel weights (not shown) attached to the rear wheels 144 to provide additional counter weight for added stability, and to counter-balance the weight of the front-end loader 100 and the weight of an accessory attached to the accessory support end 136.

In this embodiment, the boom extension hydraulic cylinder 122 extends each boom 114 by 2 to 4 feet.

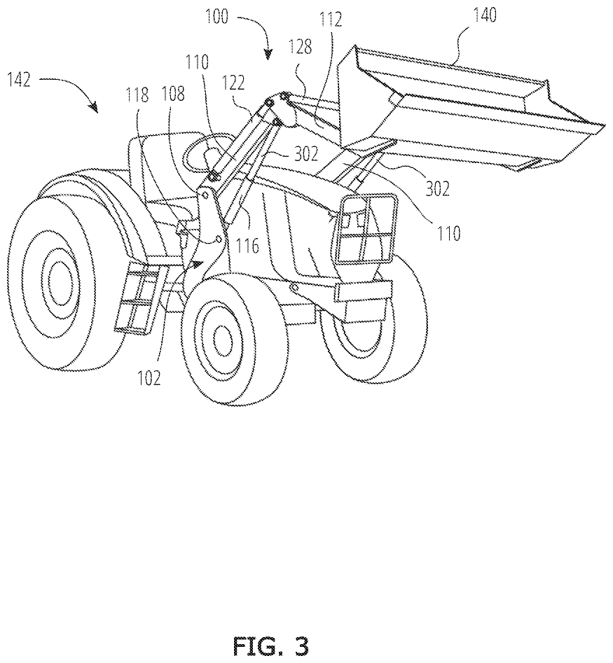

With reference to FIG. 3, a perspective front and side view is shown of the front-end loader 100, having the support structure 102 mounted on the tractor 142. The front-end loader 100 includes as an accessory the bucket 140. The bucket 140 is in a raised position, having the lift cylinder piston rod 302 of each lift hydraulic cylinder 116 is in the extended position, and each proximal leg 110 in the raised position. Each boom extension hydraulic cylinder 122 is in the retracted position, and therefore the two booms are retracted (not extended).

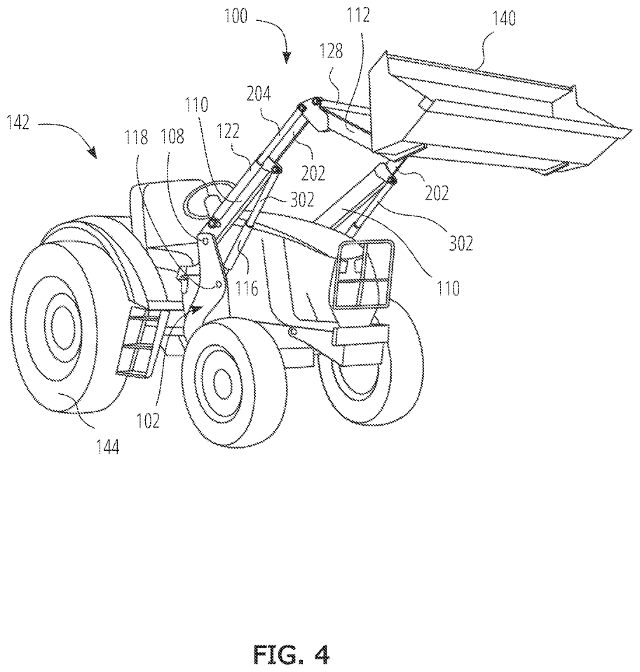

With reference to FIG. 4, a perspective front and side view is shown of the front-end loader 100, having the support structure 102 mounted on the tractor 142. The front-end loader 100 includes the bucket 140 accessory shown in a raised position. Each lift cylinder piston rod 302 of each lift hydraulic cylinder 116 in the extended position, and therefore each proximal leg 110 is in the raised position.

To further raise the bucket 140, each boom extension hydraulic cylinder 122 is in the extended position, having each extension shaft 202 of the distal leg 112 fully extended from the proximal leg receptacle 508 (shown in FIG. 5A) of the proximal leg 110 of each boom 114 (shown in FIG. 1A). Also, the extension cylinder piston rod 204 of each boom extension hydraulic cylinder 122 is in an extended position.

In some embodiments, the two rear wheels 144 include conventional wheel weights (not shown) to provide additional counter weight for added stability, and to counter-balance the weight of the front-end loader 100 and the weight of an accessory attached to the accessory support end 136. These conventional wheel weights added to the two rear wheels 144 can provide an especially important counter-balance when the boom extension hydraulic cylinder 122 of each boom 114 (shown in FIG. 1A) are in the extended position shown in this figure.

In some embodiments, the boom extension hydraulic cylinder 122 of each boom 114 is configured to extend and retract each boom 114 AFTER the lift hydraulic cylinder 116 has raised each boom 114 to a raised position.

With reference to FIG. 5A, an isometric side view is shown of the proximal leg 110, including a proximal leg attachment hole 502 configured to pivotally attach to the proximal leg pivot 108 (shown in FIG. 1A) at the upper attachment portion 106 of the support structure 102 (both shown in FIG. 1A). The proximal leg 110 also includes a proximal leg attachment pin 504 configured to support the proximal end of the boom extension hydraulic cylinder 122 (shown in FIG. 1A).

An extension end 506 of the proximal leg 110 includes a proximal leg receptacle 508 configured to receive and slidably support the extension shaft 202 of the distal leg 112 (both shown in FIG. 5B), and two lift cylinder attachment holes 510 configured to receive the distal end of the lift hydraulic cylinder 116 (shown in FIG. 1A).

With reference to FIG. 5B, an isometric side view is shown of the distal leg 112, including a distal leg attachment pin 512 configured to support the distal end of the boom extension hydraulic cylinder 122 (shown in FIG. 1A), two tilt cylinder attachment holes 514 configured to receive the proximal end of the tilt hydraulic cylinder 128 (shown in FIG. 1A), and accessory attachment holes 516 that are configured to receive and support the accessory support end 136 (shown in FIG. 1A).

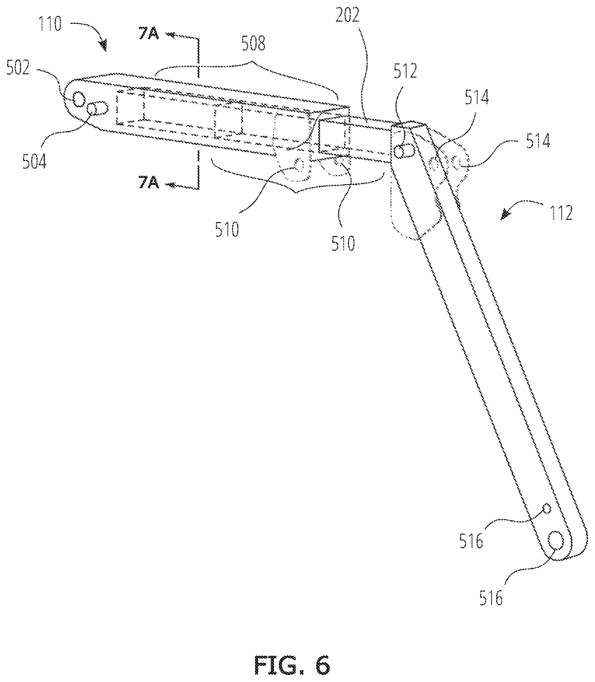

With reference to FIG. 6, an isometric side view of the proximal leg 110 and the distal leg 112 is shown, showing in hidden lines the proximal leg receptacle 508 partially receiving and slidably supporting the distal leg 112.

Included on the proximal leg 110 is the proximal leg attachment hole 502 configured to pivotally attach to the proximal leg pivot 108 (shown in FIG. 1A). In addition, the proximal leg attachment pin 504 is configured to support the proximal end of the boom extension hydraulic cylinder 122 (shown in FIG. 1A). Also, two lift cylinder attachment holes 510 are configured to receive the distal end of the lift hydraulic cylinder 116 (shown in FIG. 1A).

The distal leg 112 includes the distal leg attachment pin 512 configured to support the distal end of the boom extension hydraulic cylinder 122 (shown in FIG. 1A). Two tilt cylinder attachment holes 514 are configured to receive the proximal end of the tilt hydraulic cylinder 128 (shown in FIG. 1A), and accessory attachment holes 516 are configured to receive and support the accessory support end 136 (shown in FIG. 1A). The accessory support end 136 (shown in FIG. 1A) is configured to provide support for various accessories, such as the bucket 140 (shown in FIG. 1B).

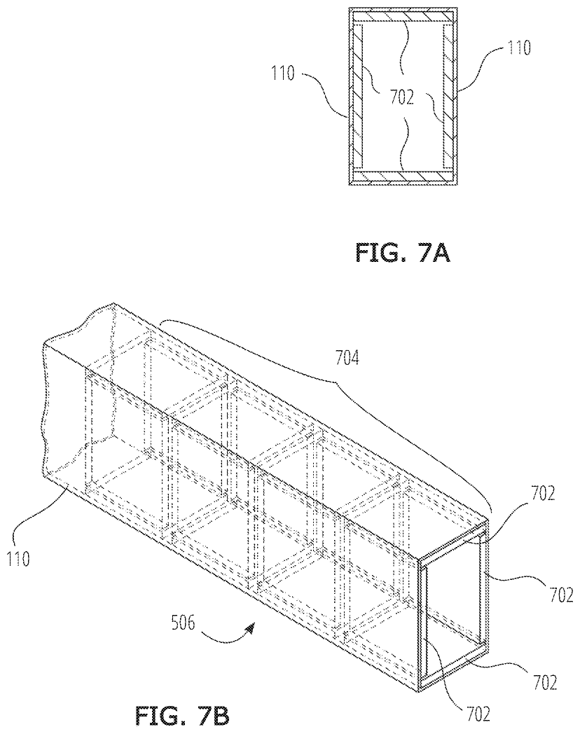

With reference to FIG. 7A, a cross sectional view of the proximal leg 110 is shown, showing four wear pads 702 that in this embodiment are included within the proximal leg receptacle 508 (shown in FIG. 5A) of the proximal leg 110. The wear pads 702 are configured to slidably support the extension shaft 202 of the distal leg 112 (both shown in FIG. 2).

With reference to FIG. 7B, an isometric view of the distal end of the proximal leg 110 is shown, also showing a hidden line view of a plurality of wear pads 704 lining the proximal leg receptacle 508 (shown in FIG. 5A). In this embodiment, the plurality of wear pads 704 are configured to slidably support the extension shaft 202 of the distal leg 112 (shown in FIG. 5B).

In this embodiment, the extension end 506 of the proximal leg 110 includes the proximal leg receptacle 508 (shown in FIG. 5A) within the proximal leg 110 that includes a plurality of wear pads 704 to slidably support the extension shaft 202 of the distal leg 112 (both shown in FIG. 5B) to provide a long service life.

With reference to FIG. 8, a perspective front and side view is shown of the front-end loader 100 mounted on the tractor 142, including pallet forks 802 attached to the accessory support end 136 of the distal leg 112 of the front-end loader 100.

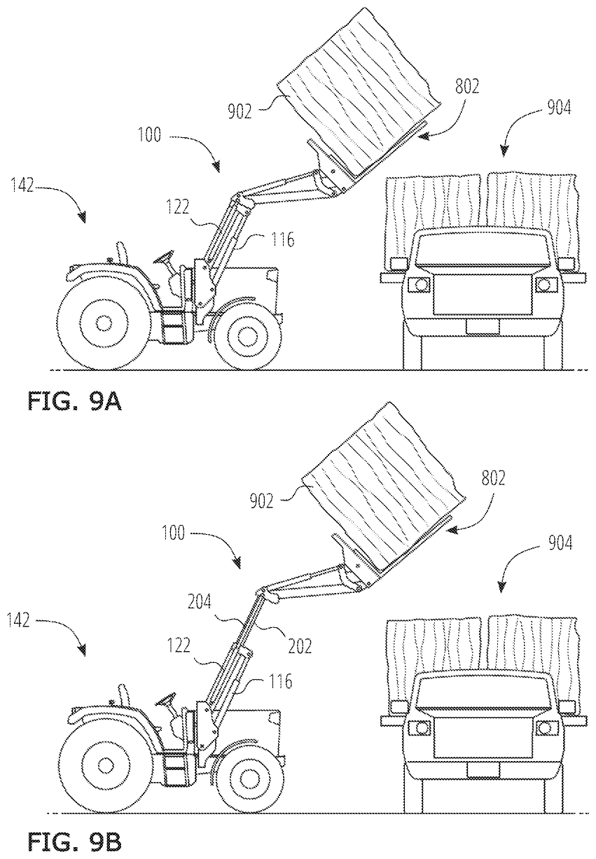

With reference to FIG. 9A, a side view is shown of the tractor 142, including the front-end loader 100 attached to pallet forks 802. The lift hydraulic cylinder 116 is in the extended position, and the pallet forks 802 are raised, however since the boom extension hydraulic cylinder 122 is in the retracted position, each boom 114 (shown in FIG. 1A) is not extended, and the bale of material 902 is not raised high enough to be successfully placed on the truck 904.

With reference to FIG. 9B, a side view is shown of the tractor 142, including the front-end loader 100 attached to pallet forks 802. The lift hydraulic cylinder 116 is in the extended position, and the pallet forks 802 are raised. Because the boom extension hydraulic cylinder 122 is in the extended position (having the both extension cylinder piston rod 204 and the extension shaft 202 in the extended position), each boom 114 (shown in FIG. 1A) is extended, and therefore the bale of material 902 is raised high enough to be successfully placed on the truck 904.

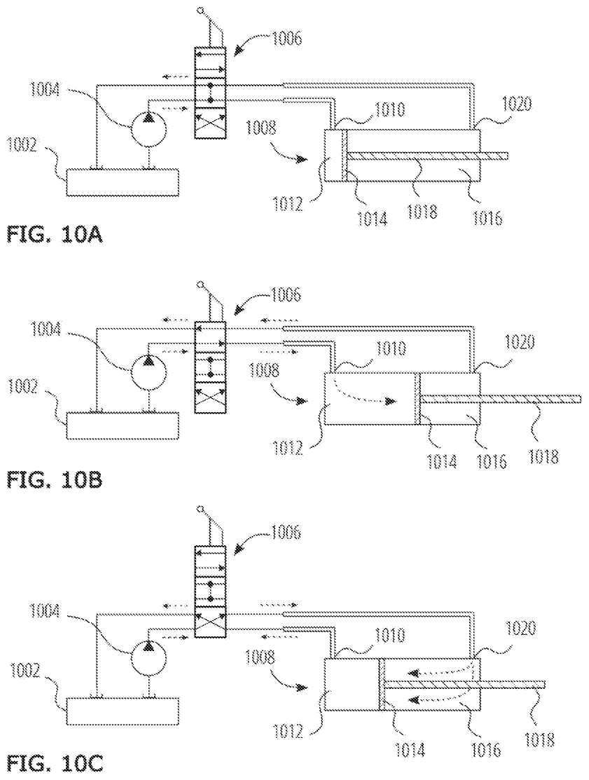

With reference to FIG. 10A, a hydraulic circuit diagram is shown of a hydraulic circuit configured to control one hydraulic cylinder 1008. The hydraulic reservoir 1102 holds a reservoir of hydraulic fluid that is pumped up to a high pressure on the valve side of the hydraulic pump 1104. The hydraulic control valve 1006 is configured in a neutral position, and the hydraulic fluid is simply returned to the hydraulic reservoir 1002, having performed no work on the hydraulic cylinder 1008. In addition, since the hydraulic control valve 1006 is in a neutral position, there is no hydraulic fluid flow at both a head port 1010 and a rod port 1020 of the hydraulic cylinder 1008. Due to the incompressibility of the hydraulic fluid, the volumes of a head fluid 1012 and a rod fluid 1016 remain constant, and a ram 1014 and a piston rod 1018 maintain a static position.

With reference to FIG. 10B, a hydraulic circuit diagram is shown of a hydraulic circuit configured to control one hydraulic cylinder 1008. The hydraulic reservoir 1002 holds a reservoir of hydraulic fluid that is pumped up to a high pressure on the valve side of the hydraulic pump 1004. The hydraulic control valve 1006 is configured in an open forward flow position, and therefore the high pressure hydraulic fluid flows through the hydraulic control valve 1006 and through the head port 1010 and into the head fluid 1012. Because the head fluid 1012 is at a higher pressure than the rod fluid 1016, the ram 1014 moves to the right, and in doing so expands the volume of the head fluid 1012, and at the same time the piston rod 1018 extends outward from the hydraulic cylinder 1008. Simultaneously, the rod fluid 1016 volume decreases and the rod fluid 1016 passes out of the rod port 1020, the hydraulic fluid returning back through the hydraulic control valve 1006 and returning to the hydraulic reservoir 1002.

With reference to FIG. 10C, a hydraulic circuit diagram is shown of a hydraulic circuit configured to control one hydraulic cylinder 1008. The hydraulic reservoir 1002 holds a reservoir of hydraulic fluid that is pumped up to a high pressure on the valve side of the hydraulic pump 1004. The hydraulic control valve 1006 is configured in an open reverse flow position, and therefore the high pressure hydraulic fluid flows through the hydraulic control valve 1006 and through the rod port 1020 and into the rod fluid 1016. Because the rod fluid 1016 is at a higher pressure than the head fluid 1012, the ram 1014 moves to the left, and in doing so expands the volume of the rod fluid 1016, and at the same time the piston rod 1018 retracts inward into the hydraulic cylinder 1008. Simultaneously, the head fluid 1012 volume decreases and the head fluid 1012 passes out of the head port 1010, the hydraulic fluid returning back through the hydraulic control valve 1006 and returning to the hydraulic reservoir 1002.

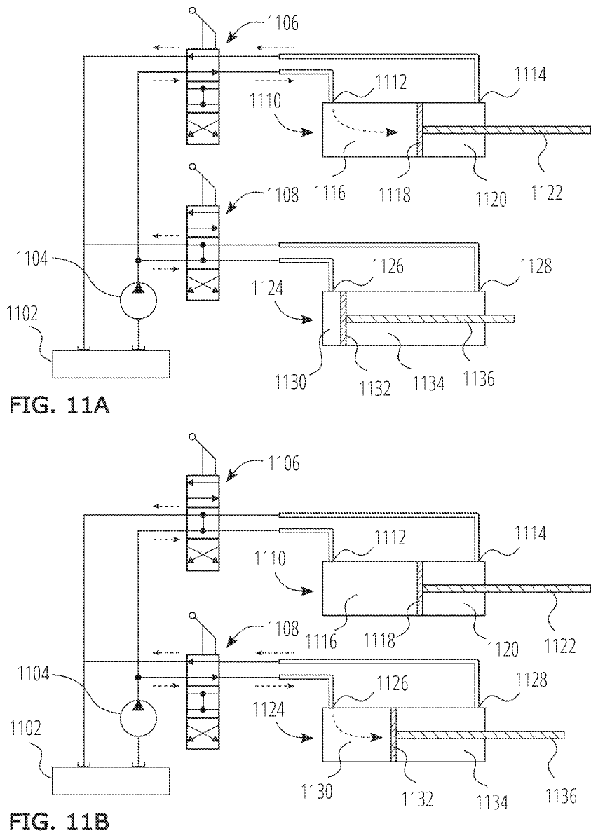

With reference to FIG. 11A, a hydraulic circuit diagram is shown of a hydraulic circuit configured to control two hydraulic cylinders, a first hydraulic cylinder 1110 and a second hydraulic cylinder 1124.

The front-end loader 100 of the invention (shown in FIG. 1A) is an example of an application of three hydraulic cylinders: the lift hydraulic cylinder 116, the boom extension hydraulic cylinder 122, and the tilt hydraulic cylinder 128 (each shown in FIG. 1A). It is understood that the description herein of the operation of two hydraulic cylinders can be similarly extended to a hydraulic circuit with three hydraulic cylinders, such as are included in the front-end loader 100 of the invention.

A hydraulic reservoir 1102 holds a reservoir of hydraulic fluid that is pumped up to a high pressure by a hydraulic pump 1104.

A first hydraulic control valve 1106 is configured in an open forward flow position, and therefore high pressure hydraulic fluid flows through the first hydraulic control valve 1106 and through a first head port 1112 and into a first head fluid 1116. Because the first head fluid 1116 is at a higher pressure than a first rod fluid 1120, a first ram 1118 moves to the right, and in doing so expands the volume of the first head fluid 1116, and at the same time a first piston rod 1122 extends outward from the first hydraulic cylinder 1110. Simultaneously, the first rod fluid 1120 volume decreases and the first rod fluid 1120 flows out of a first rod port 1114, the hydraulic fluid returning back through the first hydraulic control valve 1106 and returning to the hydraulic reservoir 1102.

A second hydraulic control valve 1108 is configured in a neutral position, and therefore the hydraulic fluid entering the second hydraulic control valve 1108 is simply returned to the hydraulic reservoir 1102, having performed no work on the second hydraulic cylinder 1124. In addition, since the second hydraulic control valve 1108 is in a neutral position, there is no hydraulic fluid flow at both a second head port 1126 and a second rod port 1128 of the second hydraulic cylinder 1124. Due to the incompressibility of the hydraulic fluid, the volumes of a second head fluid 1130 and a second rod fluid 1134 remain constant, and a second ram 1132 and a second piston rod 1136 maintain a static position.

With reference to FIG. 11 B, a hydraulic circuit diagram is shown of a hydraulic circuit configured to control two hydraulic cylinders, a first hydraulic cylinder 1110 and a second hydraulic cylinder 1124. The hydraulic reservoir 1102 holds a reservoir of hydraulic fluid that is pumped up to a high pressure by the hydraulic pump 1104.

The first hydraulic control valve 1106 is configured in a neutral position, and therefore the hydraulic fluid entering the first hydraulic control valve 1106 is simply returned to the hydraulic reservoir 1102, having performed no work on the first hydraulic cylinder 1110. Because the first hydraulic control valve 1106 is in a neutral position, there is no hydraulic fluid flow at both a first head port 1112 and a first rod port 1114 of the first hydraulic cylinder 1110. Due to the incompressibility of the hydraulic fluid, the volumes of a first head fluid 1116 and a first rod fluid 1120 remain constant, and a first ram 1118 and a first piston rod 1122 maintain a static position.

The second hydraulic control valve 1108 is configured in an open forward flow position, and therefore the high pressure hydraulic fluid flows through the second hydraulic control valve 1108 and through a second head port 1126 and into a second head fluid 1130. Because the second head fluid 1130 is at a higher pressure than a second rod fluid 1134, a second ram 1132 moves to the right, and in doing so expands the volume of the second head fluid 1130, and at the same time a second piston rod 1136 extends outward, from the second hydraulic cylinder 1124. Simultaneously, the second rod fluid 1134 volume decreases, and the second rod fluid 1134 flows out of a second rod port 1128, the hydraulic fluid returning back through the second hydraulic control valve 1108 and returning to the hydraulic reservoir 1102.

Other modifications and implementations will occur to those skilled in the art without departing from the spirit and the scope of the invention as claimed. Accordingly, the above description is not intended to limit the invention, except as indicated in the following claims.

What is claimed is:

1. A front-end loader for attachment to a tractor or a rubber tired construction backhoe, the front-end loader including hydraulic cylinders, each hydraulic cylinder having a cylinder barrel, a piston rod, a proximal end, and a distal end, the front-end loader comprising:
a support structure configured to be attached to the tractor, the support structure having an upper attachment portion and a lower attachment portion;
two booms, each boom including:
a proximal leg having a pivot end and an extension end, the pivot end being pivotally attached to the upper attachment portion, and
a boom extension hydraulic cylinder, having the proximal end attached to the proximal leg, and
a distal leg having an extension end and an accessory support end, the extension end of the distal leg being attached to the distal end of the boom extension hydraulic cylinder;
a lift hydraulic cylinder having the proximal end pivotally attached to the lower attachment portion of the support structure, and the distal end pivotally attached to the extension end of the proximal leg; and
a tilt hydraulic cylinder having the proximal end being pivotally attached to the extension end of the distal leg, and the distal end of the tilt hydraulic cylinder configured to pivotally attach to an implement assembly that is configured to be pivotally attached to the accessory support end of the distal leg.

2. The front-end loader of claim 1, wherein the distal leg of each boom includes an extension shaft that is fixedly attached to the extension end of the distal leg, and the extension shaft is slidably supported by a receptacle included within the extension end of the proximal leg.

3. The front-end loader of claim 2, wherein the receptacle within the extension end of the proximal leg includes wear pads to slidably support the extension shaft of the distal leg to provide a long service life.

4. The front-end loader of claim 1, wherein the two booms have a cross member attached to each boom of the two booms.

5. The front-end loader of claim 1, wherein each boom extension hydraulic cylinder extends each boom by 2 to 4 feet.

6. The front-end loader of claim 1, wherein the boom extension hydraulic cylinder is configured to extend and retract the two booms AFTER the lift hydraulic cylinder has raised the two booms to a raised position.

7. The front-end loader of claim 1, further including:
conventional wheel weights to provide additional counter weight for added stability.

8. The front-end loader of claim 1, wherein the distal leg extends from the proximal leg at a 105 to 135 degree boom legs angle.

9. The front-end loader of claim 1, wherein the distal end of each distal leg of the two booms is configured to attach to at least one of: a bucket, pallet forks, hay forks, bale spears.
